(19) United States
(12) Patent Application Publication
(10) Pub. No.: US 2006/0190381 A1
(43) Pub. Date: Aug. 24, 2006

(54) Collective purchase model for medical products

(76) Inventor: Michael J. Sweeney, Jacksonville, FL (US)

Correspondence Address: TAFT, STETTINIUS & HOLLISTER LLP, SUITE 1800, 425 WALNUT STREET, CINCINNATI, OH, 45202-3957, US

(21) Appl. No.: 11/048,110

(22) Filed: Feb. 1, 2005

(51) Int. Cl. G06Q 40/00

(52) U.S. Cl. 705/37

(57) ABSTRACT

A procurement method for the collective purchase of products, including medical products such as cardiology implant devices, for use by members of a consortium. The members of the consortium can be physicians such as cardiologists. An advisory panel composed of consortium members first reviews available products in a relevant product category and identifies three or more suppliers for further consideration. Following solicitation of bids from these suppliers, one or two suppliers are selected as preferred suppliers for the product category. Each consortium member's supply requirements are purchased from the preferred supplier by the consortium's purchasing agent, or by the end user (such as a hospital). Groups of multiple consortiums, each of which handles purchasing of products in a different geographic location or a different medical specialty, are also described.

### BACKGROUND OF THE INVENTION

This invention relates to a procurement method for the collective purchase of products, particularly medical products such as cardiology implant devices, for use by members of a consortium.

The prior art contains interactive models that allow medical staff members to access information regarding products and receive price quotes from vendors of the products. The prior art also contains interactive models that allow medical staff members to purchase products by auction over a computer-implemented network. Additionally, the prior art describes a system that facilitates the selection and ordering of products by medical staff members through an administrative agent. These prior art methods, however, do not provide a step for review of available products and designation of preferred products by an advisory panel. Additionally, these prior art methods do not pool the buying power of physicians from different practice groups.

The present invention addresses these deficiencies in the prior art by providing for the collective purchase of products by physicians who are members of a buying consortium, and by providing a step for an advisory panel of the buying consortium to review available products and designate preferred products.

### SUMMARY

The present invention is generally directed to a procurement method for the collective purchase of medical components and/or services for use by members of a consortium. The consortium can evaluate the various product offerings in a relevant product category and select one or more specific products or manufacturers to be used as preferred suppliers of that product to the consortium's members. This procurement method allows the members of the consortium to pool their buying power to receive favorable pricing and to ensure that the products used by the consortium's members meet the consortium's standards for quality.

Accordingly, it is an object of the present invention to provide a procurement method for procuring medical components and/or services, including the steps of: (a) forming a consortium of medical practitioners; (b) evaluating by the consortium a first plurality of manufacturers of products in a relevant product category; (c) determining by the consortium a second plurality of the manufacturers as being clinically acceptable, the determining step being based on the results of the evaluating step; (d) soliciting bids by the consortium from each of the clinically acceptable manufacturers; (e) selecting by the consortium at least one of the clinically acceptable manufacturers to be a preferred supplier of products in the relevant product category; and (f) forming a supplier agreement with each supplier selected in step (e) pursuant to the bid submitted by that supplier. A contracting agent can be the majority owner of the consortium while the members are minority owners of the consortium, and step (f) can be performed by the contracting agent. The relevant product category can be a category of products used in the practice of medicine, such as cardiology-related products. In a detailed embodiment, the evaluating and determining steps are performed by members of an advisory panel of the consortium.

In a more detailed embodiment, the method further includes the step of: (g) purchasing products in the relevant product category from a preferred supplier for that product category. This purchasing step can be performed by a hospital with which a consortium member is affiliated, by a consortium member, or by the contracting agent. In the case where a hospital or a consortium member performs the purchasing step, the contracting agent receives an administrative fee from the preferred supplier for each purchase order pursuant to the supplier agreement. In the case where the contracting agent performs the purchasing step, the method can further comprise the step of: (h) the purchasing agent collecting payment for the product from an end user and delivering the payment to the preferred supplier of the product. The purchasing step (g) can be repeated each time products in the relevant product category are needed.

Steps (a) through (f) of the method can be repeated at the discretion of the members of the consortium or at the discretion of the members of the advisory panel.

In another detailed embodiment of the present invention, the contracting agent is the majority owner of a plurality of consortiums. Each of the plurality of consortiums can purchase products for use in a different geographic location or purchase products in a different relevant product category. Additionally, the contracting agent can be the majority owner of a plurality of geographically-defined first-tier consortiums, each of which is the majority owner of a plurality of second-tier consortiums differentiated by medical specialty. Alternatively, the first-tier consortiums can be differentiated by medical specialty, and the second-tier consortiums can be geographically-defined.

### BRIEF DESCRIPTION OF THE DRAWINGS

FIG. 1 shows a block diagram of the steps of the method according to an exemplary embodiment of the present invention.

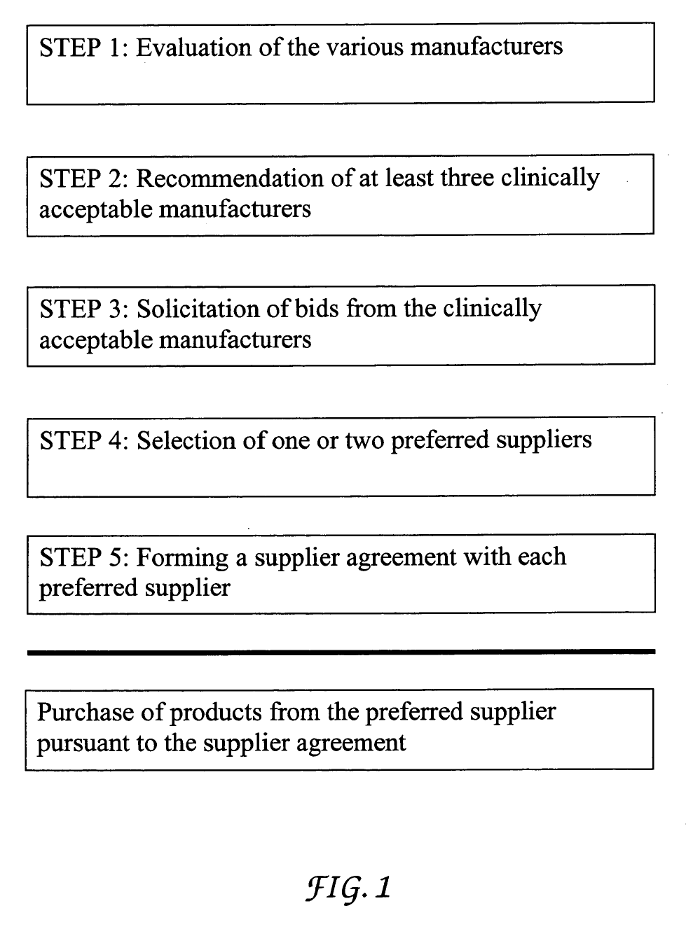

### DETAILED DESCRIPTION

The present invention is generally directed to a procurement method for the collective purchase of medical components and/or services by members of a consortium (hereinafter referred to as the “Consortium”). The Consortium can evaluate the various product offerings in a relevant product category and select one or more specific products or manufacturers to be used as preferred suppliers of that product to the Consortium's members. This procurement method, which is described in detail in the following paragraphs, allows the members of the Consortium to pool their buying power to receive favorable pricing and to ensure that the products used by the Consortium's members meet the Consortium's standards for quality.

In an exemplary embodiment, this invention can be practiced as a purchasing model used by a cardiology consortium to purchase surgical implants and other cardiology-related products for resale to hospitals. The Consortium is a separate business entity, such as a corporation or limited liability company, whose members and minority owners are cardiologists. The manager and majority owner of the Consortium is another entity (hereinafter referred to as the “Agent”) that will conduct the negotiations and contract with suppliers on behalf of the Consortium. The objective of the Consortium is to pool the buying power of its member cardiologists, collectively negotiating with suppliers of the surgical implants and other cardiology-related products to obtain favorable prices on these items. The resulting alignment of incentives between hospitals and the cardiologists will provide hospital systems with competitive, predictable pricing at levels that are not attainable in the other business models.

For each product category (e.g., pacemakers), the Consortium selects one or two preferred suppliers according to the following steps. First, the Consortium has an advisory panel (composed of Consortium members, who can be elected to serve on the advisory panel on a rotational basis and be compensated for such service) that evaluates the various manufacturers of products in the relevant product category. Based on this evaluation, the advisory panel recommends at least three clinically acceptable manufacturers for use by member physicians. Next, the Consortium (through the Agent) solicits bids from these competing manufacturers. Finally, one or two of the manufacturers submitting the bids will be selected as preferred suppliers for the product category. This selection of the preferred suppliers can be based upon bid price, product quality, level of service, or other factors deemed relevant by the advisory panel. These preferred suppliers will then be used to supply products in that product category (e.g., pacemakers) to hospitals for use by Consortium member physicians. Although the preferred suppliers will be the suppliers of choice for the member cardiologists to use for products in the relevant product category, member cardiologists retain the freedom to choose a product from another supplier if such product is deemed more appropriate for a particular patient.

The advisory panel will periodically review the performance (including quality of the products themselves and the service provided by the supplier) of the preferred suppliers in each product category, with the possibility of conducting a new selection of preferred suppliers for a product category if the current suppliers are determined to be unsatisfactory. Additionally, the preferred suppliers can be designated for a fixed contract term (three years in an exemplary embodiment), and the advisory panel can choose to extend such preferred supplier contracts for an additional fixed term at its discretion.

With this method, the incentives of physicians and hospitals are aligned by the pooling of their buying power, and this market consolidation will enable suppliers who are selected by the Consortium to enjoy a substantial increase in their sales. As cardiology implant procedures are now performed in most hospital settings, there is extreme fragmentation of the market with the resultant loss of negotiation leverage by the purchaser, or hospital. The goal of the Consortium, through the actions and compliance of its physician members, is to offer its limited number of suppliers the opportunity to access a large volume of cases over the life of an extended contract, with the potential that such suppliers could substantially increase their sales. Hospitals and Consortium members should be able to obtain very favorable pricing on cardiology products through the concentration of their market share over a small number of suppliers in each product category.

When a member cardiologist needs to use a product in a product category that is handled by the Consortium, the hospital will purchase the product from one of the preferred suppliers for that product category, at the price and terms negotiated by the Consortium for that particular product. For each sale, the preferred supplier will pay an administrative fee to the Consortium pursuant to the contract negotiated between the preferred supplier and the Consortium.

Alternatively, in another embodiment, the Consortium can purchase the products from the preferred supplier and resell the products to the hospital. The Consortium does not need to warehouse product or store inventory. Instead, the products can be ordered by the operating room staff as directed by the implanting cardiologists, consistent with their preferences and with the requirements of the particular patient. Purchase orders can be submitted to the Agent by the vendor's representative or the operating room staff in accordance with inventory usage. These purchase orders can be reviewed for payment by the Agent staff, cross checked with invoicing from the vendor, and adjudicated to create invoices for submission to the hospital system. The financial transactions can be processed through the Agent as the company purchases each product from the preferred vendor at previously contracted pricing. The Agent can then handle the billing and collection process for the products with the hospital, again in compliance with the contracts in place at the time of the procedure.

As mentioned above, the Agent will conduct the negotiations and contract with suppliers on behalf of the Consortium. The Agent can provide contract negotiation and implementation, financial and operational management, advisory panel support services, organization and strategic planning, and all other duties and responsibilities of the Consortium. The Agent retains ownership of a majority of the equity of the Consortium and has the sole authority to enter into binding agreements on behalf of the Consortium. Minority owners (who are cardiologists in the exemplary embodiment described herein) can be required to make an initial financial commitment to purchase their individual ownership interest in the Consortium. Each offeree, as an accredited investor, will be eligible to purchase one or more units in the Consortium during its initial organizational phase. While this investment entitles each member to share in any and all proceeds from the Consortium, investment and ownership do not necessarily need to be proportional to device implant case volumes. In addition, there does not need to be any obligation of members to restrict their (or their physician shareholders' or members') implant selection to specific vendors or manufacturers. Provisions can be included for the removal of members from the Consortium, for example, upon a vote of the members and consent of the Agent. Equity valuation for repurchase of Consortium membership interests in case of discharge can be the agreed or appraised value as of the day of the vote to discharge.

The Agent, as the manager and majority owner of the Consortium, can take the lead in creating the Consortium. By extension, the Agent can form a plurality of consortiums, each consortium functioning as described herein. Each of the plurality of consortiums can operate in a different geographic area or can handle products in a different medical specialty. For example, within a given geographic area, the Agent may have one consortium to purchase cardiology implant products, one consortium to purchase orthopedic and spine implant products, and perhaps other consortiums to purchase other categories of products. The members of each consortium can be different based on the product categories purchased by each consortium. For example, the members of a consortium that purchases cardiology implant products can be cardiologists, and the members of a consortium that purchases orthopedic and spine implant products can be orthopedic surgeons.

The two types of consortiums described in the preceding paragraph, differentiated by geographic area or medical specialty, can be combined. For example, the Agent can form a plurality of geographically-defined first-tier consortiums, each of which covers a different geographical area. Each of these consortiums can then create a plurality of second-tier consortiums, each of which covers a different medical specialty. Each of these second-tier consortiums will handle collective purchase of products in its designated medical specialty within the geographic area of its parent consortium (the first-tier consortium that is defined by geography). Alternatively, the first-tier consortiums can be defined by medical specialty, and the second-tier consortiums can be defined by geographic area. By allowing a two-tiered structure of consortiums, the Agent can use its presence in multiple geographic markets to influence pricing, access, and contracting with manufacturers. At the same time, creating multiple, specialty-specific, single-market consortiums focuses the influence of the buying group and also promotes compliance by the member physicians. The ability of the Agent to combine a local incentive to physicians and a broad impact on the product markets results in lower prices for hospitals and other final payers.

Having described the invention with reference to exemplary embodiments, it is to be understood that the invention is defined by the claims, and it is not intended that any limitations or elements describing the exemplary embodiment set forth herein are to be incorporated into the meanings of the claims unless such limitations or elements are explicitly listed in the claims. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

What is claimed is:

1. A procurement method for procuring medical components and/or services,: comprising the steps of:
(a) forming a consortium of medical practitioners;
(b) evaluating by the consortium a first plurality of manufacturers of products in a relevant product category;
(c) determining by the consortium a second plurality of the manufacturers as being clinically acceptable, the determining step being based on the results of the evaluating step;
(d) soliciting bids by the consortium from each of the clinically acceptable manufacturers; and
(e) selecting by the consortium at least one of the clinically acceptable manufacturers to be a preferred supplier of products in the relevant product category; and
(f) forming a supplier agreement with each supplier selected in step (e) pursuant to the bid submitted by that supplier.

2. The method of claim 1, wherein
a contracting agent is the majority owner of the consortium and the members are minority owners of the consortium; and wherein
step (f) is performed by the contracting agent.

3. The method of claim 2, wherein
the relevant product category is a category of products used in the practice of medicine.

4. The method of claim 3, wherein
the relevant product category is cardiology-related products.

5. The method of claim 2, wherein
the evaluating and determining steps are performed by members of an advisory panel of the consortium.

6. The method of claim 5, wherein
the members of the advisory panel are physicians.

7. The method of claim 6, wherein
the members of the advisory panel are cardiologists.

8. The method of claim 2, further comprising the step of:
(g) purchasing products in the relevant product category from a preferred supplier for that product category.

9. The method of claim 8, wherein
the purchasing step (g) is performed by a hospital with which a member of the consortium is affiliated; and wherein
the contracting agent receives an administrative fee from the preferred supplier for each purchase order pursuant to the supplier agreement.

10. The method of claim 8, wherein
the purchasing step (g) is performed by a member of the consortium; and wherein
the contracting agent receives an administrative fee from the preferred supplier for each purchase order pursuant to the supplier agreement.

11. The method of claim 8, wherein
the purchasing step (g) is performed by the contracting agent on behalf of the members of the consortium.

12. The method of claim 11, further comprising the step of:
(h) the contracting agent collecting payment for the product from an end user and delivering the payment to the preferred supplier of the product.

13. The method of claim 12, wherein
the end user is a hospital.

14. The method of claim 8, further comprising the step of:
repeating the purchasing step (g) each time the products in the relevant product category are needed.

15. The method of claim 8, further comprising the step of:
repeating steps (a) through (f) at the discretion of the members of the consortium.

16. The method of claim 15, wherein
the members of the consortium are physicians.

17. The method of claim 16, wherein
the members of the consortium are cardiologists.

18. The method of claim 16, wherein
the relevant product category is a category of products used in the practice of medicine.

19. The method of claim 18, wherein
the relevant product category is cardiology-related products.

20. The method of claim 14, wherein
the evaluating and determining steps are performed by members of an advisory panel.

21. The method of claim 20, wherein
the members of the advisory panel are physicians.

22. The method of claim 21, wherein
the members of the advisory panel are cardiologists.

23. The method of claim 20, wherein
the members of the consortium are physicians.

24. The method of claim 23, wherein
the members of the consortium are cardiologists.

25. The method of claim 20, wherein
the relevant product category is a category of products used in the practice of medicine.

26. The method of claim 25, wherein
the relevant product category is cardiology-related products.

27. The method of claim 20, further comprising the step of:
repeating steps (a) through (f) at the discretion of the advisory panel.

28. The method of claim 27, wherein
the members of the advisory panel are physicians.

29. The method of claim 28, wherein
the members of the advisory panel are cardiologists.

30. The method of claim 27, wherein
the members of the consortium are physicians.

31. The method of claim 30, wherein
the members of the consortium are cardiologists.

32. The method of claim 27, wherein
the relevant product category is a category of products used in the practice of medicine.

33. The method of claim 32, wherein
the relevant product category is cardiology-related products.

34. The method of claim 2, wherein
the contracting agent is the majority owner of a plurality of consortiums.

35. The method of claim 34, wherein
each of the plurality of consortiums purchases products for use in a different geographic location or purchases product categories for use in a different medical specialty.

36. The method of claim 34, wherein
the contracting agent is the majority owner of a plurality of first-tier consortiums, each of which purchases products for use in a different geographic location; and wherein
each of the plurality of first-tier consortiums is the majority owner of a plurality of second-tier consortiums, each of which purchases product categories for use in a different medical specialty.

37. The method of claim 34, wherein
the contracting agent is the majority owner of a plurality of first-tier consortiums, each of which purchases products for use in a different medical specialty; and wherein
each of the plurality of first-tier consortiums is the majority owner of a plurality of second-tier consortiums, each of which purchases product categories for use in a different geographic location.

38. The method of claim 2, wherein
the first plurality of manufacturers includes substantially every manufacturer of products in the relevant product category.

39. The method of claim 2, wherein
the second plurality of manufacturers is fewer in number than the first plurality of manufacturers.
